(19) United States
(12) Patent Application Publication
(10) Pub. No.: US 2010/0011734 A1
(43) Pub. Date: Jan. 21, 2010

(54) HARVESTING MACHINE

(76) Inventor: Itzhak Agadi, Oranit (IL)

Correspondence Address: Pearl Cohen Zedek Latzer, LLP, 1500 Broadway, 12th Floor, New York, NY, 10036, US

(21) Appl. No.: 12/518,501

(22) PCT Filed: Dec. 11, 2006
(86) PCT No.: PCT/IL06/01419

§ 371 Date: Jun. 10, 2009

(51) Int. Cl. A01D 46/16

(52) U.S. Cl. 56/40

(57) ABSTRACT

A harvesting device for harvesting cotton or similar crop plants comprising: a housing mountable on a vehicle or a cart and adapted to be advanced along a row of the plants and provided with a gap through which each plant may pass through as the housing is advanced; two substantially parallel elongated revolvable bar assemblies placed in housing, each consisting of at least one spiral bar rotatable about a first axis, the first axis revolvable about a second axis, whereby when the device is advanced along a row of plants and the revolvable bar assemblies are rotated the spiral bars impart a plant as it passes through the gap in the housing a series of lashes that cause separation of cotton bolls from the plant and their conveying and collection.

### FIELD OF THE INVENTION

The present invention relates to agricultural machinery. More particularly it relates to an improved cotton and similar crop-harvesting device.

### BACKGROUND OF THE INVENTION

In crop harvesting, and in particular in cotton harvesting, it is desired to harvest the inflorescence without any residues like stem portions, leaves etc. This is a major aim in the design of modern harvesting machinery and a target most desired. Manually harvesting can of course be very fastidious and accurate way of picking only the cotton bolls, leaving out any undesired stems, foliage, or dirt, but it is extremely time-consuming and very uneconomical. Automatic harvesting by harvesting machines, on the other hand, is not that accurate, and as a result the collected cotton bolls are mixed with dirt, leaves, stem portions and even pebbles and stones that are found in the field. In fact, the presence of stones can prove hazardous to the machinery as they can damage moving parts and, break or even pierce through metal walls of the machine, causing damages and delays due to frequently-forced repairs and maintenance work.

The cotton plant is a low-rising bush, which is normally man-cultivated, planted in straight rows. This allows cotton-harvesting machinery to collect the cotton bolls while advancing along the row. Many attempts were made to provide harvesting machinery that overcomes the problems raised herein.

First mechanization of cotton harvesting appeared as early as 1893 with the granting of U.S. Pat. No. 510,730 to Todd.

U.S. Pat. No. 4,470,245 (Agadi) titled COTTON HARVESTING METHOD AND MACHINE, filed 1982, incorporated herein by reference, disclosed a method for harvesting cotton including cutting the cotton plant a short distance above ground, clampingly hold the bush with its main stem substantially in the vertical and imparting revolving movement to the plant at high speed, thus causing cotton bolls to be thrown off the plant by centrifugal force and collecting the thrown off bolls.

U.S. Pat. No. 5,077,964 (Kabat) titled CROP HARVESTING METHOD AND APPARATUS, filed 1988, incorporated herein by reference, disclosed apparatus and method of harvesting dry beans and similar crops supported on plants standing in rows in a field comprising severing the plant above ground level, transporting the severed plants to a chamber and discharging such plants from the chamber to the receiver of a combine from which the plants are delivered to the combine threshing mechanism at which the crop is separated from the plants stems, foliage and other debris.

GB 2,131,664 (Agadi) disclosed a harvesting machine having a two pairs of opposite-revolving helical or zig-zag bars, which shake the cotton bush in order to detach the cotton bolls from the stem.

Apart from the desire to exclude foliage, stems and other debris from the collected crop, it is also very important an aim to prevent any harm to the longer fibers of the crop, for excessive force exerted on the plant and on the crop during harvesting may cause damage to the harvested crop, such as breaking the longer fibers of the crop.

It is an object of the present invention to provide harvesting device that facilitates harvesting of bush-grown crops and in particular of cotton bolls without causing any harm to the longer fibers of the crop.

Further object is to provide such device that allows clean and precise harvesting collecting only the desired crop while at the same time not picking undesired foliage, stems, stones or other debris.

### BRIEF DESCRIPTION OF THE INVENTION

It is therefore thus provided, in accordance with a preferred embodiment of the present invention, a harvesting device for harvesting cotton or similar crop plants comprising:

a housing mountable on a vehicle or a cart and adapted to be advanced along a row of the plants and provided with a gap through which each plant may pass through as the housing is advanced;

two substantially parallel elongated revolvable bar assemblies placed in housing, each consisting of at least one spiral bar rotatable about a first axis, the first axis revolvable about a second axis,

whereby when the device is advanced along a row of plants and the revolvable bar assemblies are rotated the spiral bars impart a plant as it passes through the gap in the housing a series of lashes that cause separation of cotton bolls from the plant and their conveying and collection.

Furthermore, in accordance with some preferred embodiments of the present invention, the housing is mounted on a self-propelled motor-powered vehicle.

Furthermore, in accordance with some preferred embodiments of the present invention, the revolvable bar assemblies are powered by the motor of the self-propelled motor-powered vehicle.

Furthermore, in accordance with some preferred embodiments of the present invention, each of the revolvable bar assemblies comprises two or more spiral bars rotatable about a first axis, the first axis revolvable about a second axis.

Furthermore, in accordance with some preferred embodiments of the present invention, each of the revolvable bar assemblies comprises three spiral bars rotatable about a first axis, the first axis revolvable about a second axis.

Furthermore, in accordance with some preferred embodiments of the present invention, the two revolvable bar assemblies are driven simultaneously and in synchrony by a transmission consisting of interlaced transmission cogs.

Furthermore, in accordance with some preferred embodiments of the present invention, the two revolvable bar assemblies are adapted to be drawn closer or further apart so as to allow different sizes of plants to be harvested.

Furthermore, in accordance with some preferred embodiments of the present invention, the revolvable bar assemblies are positioned diagonally with respect to the ground.

Furthermore, in accordance with some preferred embodiments of the present invention, the revolvable bar assemblies are rotatable in opposite directions.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending Claims. Like components are denoted by like reference numerals.

FIG. 1 illustrates a general view of a harvesting device in accordance with a preferred embodiment of the present invention, mounted on a combine.

FIG. 2b illustrates a harvesting device in accordance with a preferred embodiment of the present invention.

FIG. 2c illustrates the operation of the revolving members of a harvesting device of the present invention.

FIG. 3 illustrates the adjustability of the revolvable members.

FIG. 4 illustrates the operation of the revolvable members in jolting the cotton bolls off the stems.

FIG. 5 illustrates the arrangement of two rotating bar assemblies, according to a preferred embodiment of the present invention.

FIG. 6 illustrates the motion of the rotating rods as the rotating rod assemblies are advanced over a row of plants 22.

FIG. 7 illustrates a frontal view the orientation and arrangement of a pair of rotating bar assemblies in front of a cotton plant.

FIG. 8 illustrates the advance of a pair of rotating bar assemblies along a row of cotton plants.

### DETAILED DESCRIPTION OF THE INVENTION AND FIGURES

It was found that a whiplash motion imparted on the cotton plant causes the cotton boll to break away from the plant and be tossed off it.

A main aspect of the present invention is the harvesting of a crop, in particular cotton, by way of whipping the cotton plant, jolting it rapidly in substantially opposite directions, so that the cotton boll is tossed off the plant and collected by the harvesting device.

Another aspect of the present invention is the provision of a harvesting device having whipping revolving members that are spaced apart so as to receive a cotton plant between them and when turning to impart a substantially opposite jolting action that cause cotton bolls to be thrown off the plant. These cotton bolls are confined to a housing and thus fall onto and are caught by a conveyer and are conveyed to a container where they are collected. The novel design of the harvesting device of the present invention is aimed at inflicting a whiplash to the cotton plant that causes the cotton bolls to detach from the stem.

Another aspect of the present invention is the provision of a novel mechanism that imparts the jolting action to the cotton plant, comprising a pair of substantially parallel revolving assemblies each comprising at least one spirally oriented rod rotating about a first axis of rotation, the first axis of rotation itself rotating about a second axis of rotation. Typically there are two or more than one such rods.

In a preferred embodiment of the device of the present invention the whipping revolving assemblies are turned in opposite directions and are placed near enough so that the spiral rods of both revolving assemblies can hit the plant when it is positioned between them.

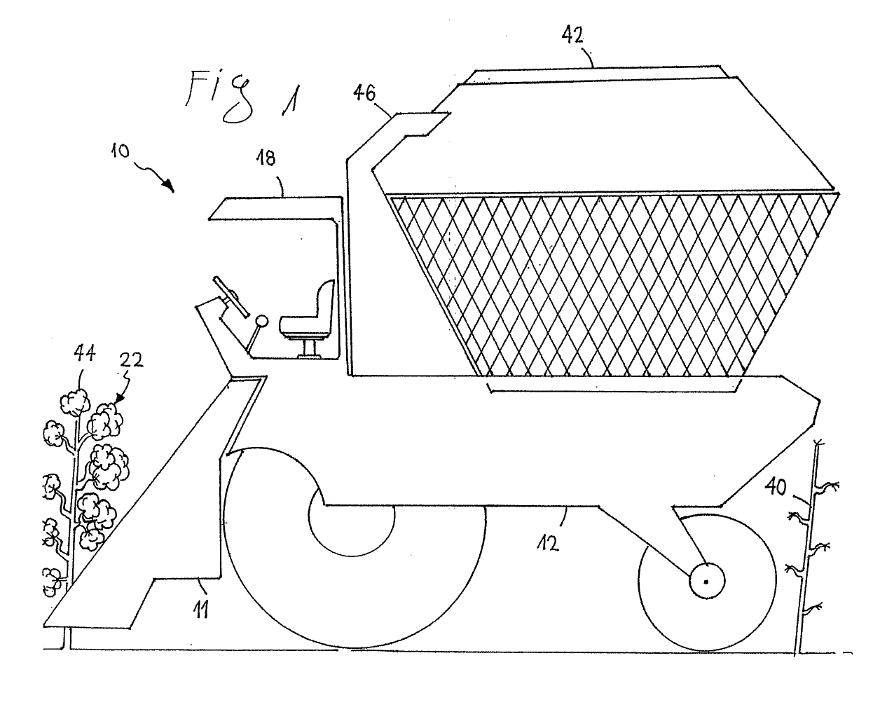

Reference is now made to FIG. 1 illustrating a general view of a harvesting device in accordance with a preferred embodiment of the present invention. A combine generally denoted by numeral 10 is shown. A wheeled vehicle 12 is arranged for forward motion. In the embodiment presented in FIG. 1 the vehicle 12 is self-propelled and includes a driver's cabin 18. The driver drives the harvester and ensures alignment of the harvesting device with the crop rows, so as to facilitate receiving of the cotton plants 22 by the harvesting device.

The combine 10 carries a harvesting device 11, in accordance with a preferred embodiment of the present invention, attached to the vehicle at its forward end in a diagonal position so as to receive a row cotton plants 22 of the field as it is driven forward. The diagonal position of the harvesting device facilitates the shaking of the cotton plant gradually as its lower stem enters the device prior to its higher stem, and the progression of the vehicle introduces the next plant to the harvesting device and so on. Generally in many cases the diagonal position of the harvesting device is recommended to be in the range of 45 to 75 degrees with respect to the horizon (the ground). The collected cotton bolls 44 are jolted from the plant by the operating mechanism of the harvesting device and are trapped inside the harvesting device's chassis and are conveyed on side conveyers (not shown in the figure) and are transferred to a collecting container 42. The cotton bolls 44 are sucked from the outlet of the harvesting device by a vacuum pipe 46 and are tossed into the container 42. The stripped plants 40 remain rooted to the ground as the combine passes beyond them. The device of the present invention may be mounted on a self-propelled vehicle or be towed by a vehicle or a farm animal, or be advanced manually.

FIG. 2a illustrates a revolving assembly 20 for use in a harvesting device in accordance with a preferred embodiment of the present invention. The revolving assembly shown in this figure comprises three spiral rods 24, spinning about axis 23, pivotally connected at one end to orbital cog-wheel 32 which is pivotally connected to base plate 28 and at the other opposite end to opposite plate 26. The orbital cog-wheels 32 communicate with central cog-wheel 34, which is coaxial with main axis 30, but independent from it in terms of rotation. In some embodiments of the present invention the central cog-wheel is fixed and does not revolve, but in other preferred embodiments of the present invention it may be subjected to a rotation that is independent from the rotation of main axis 30 and base plate 28, which is firmly fixed to main axis 30.

When main axis 30 is rotated, it rotates base plate 28, causing the orbital cog-wheels 32 to rotate as they interact with the fixed central cog-wheel 34. This causes the spiral bars to rotate about axis 23, while axis 23 rotates about main axis 30. The result is an assembly of rotating spiral rods.

FIG. 2b illustrates a detail of the revolving assembly. One spiral rod 24 spins about axis 23, the diameter of the spin denoted by “d”.

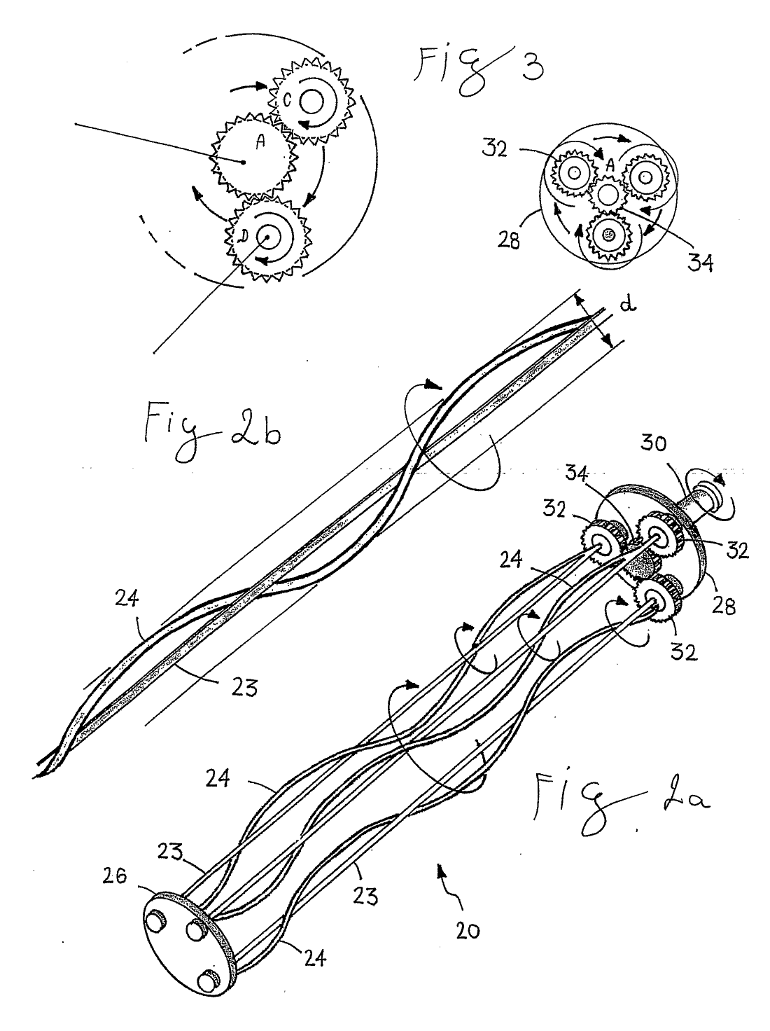

FIG. 3 illustrates a frontal view of base plate 28. It can be appreciated that when base plate 28 is rotated in the direction of the arrow (in this example clockwise), the three cog-wheels 32 orbit central cog-wheel 34 as they rotate about their own axis.

The special arrangement of the revolving rod assembly ensures that the rods continuously engage and disengage with the cotton plant, jolting it and causing the cotton bolls to be shaken off the plant and tossed away.

FIG. 4 illustrates the engagement and disengagement mechanism of a pair of rotating bar assemblies with the cotton plant. The top illustration represents the general motion of the orbital cog-wheels 32, whereas the arrows at the top represent the local motion of the spiral rods at a given point. The two assemblies are positioned substantially parallel to each other. When operating, the two assemblies rotate in opposing directions, closing in on the plant, while the spiral rods move in and out when passing over the plant (due to their revolution about their axis).

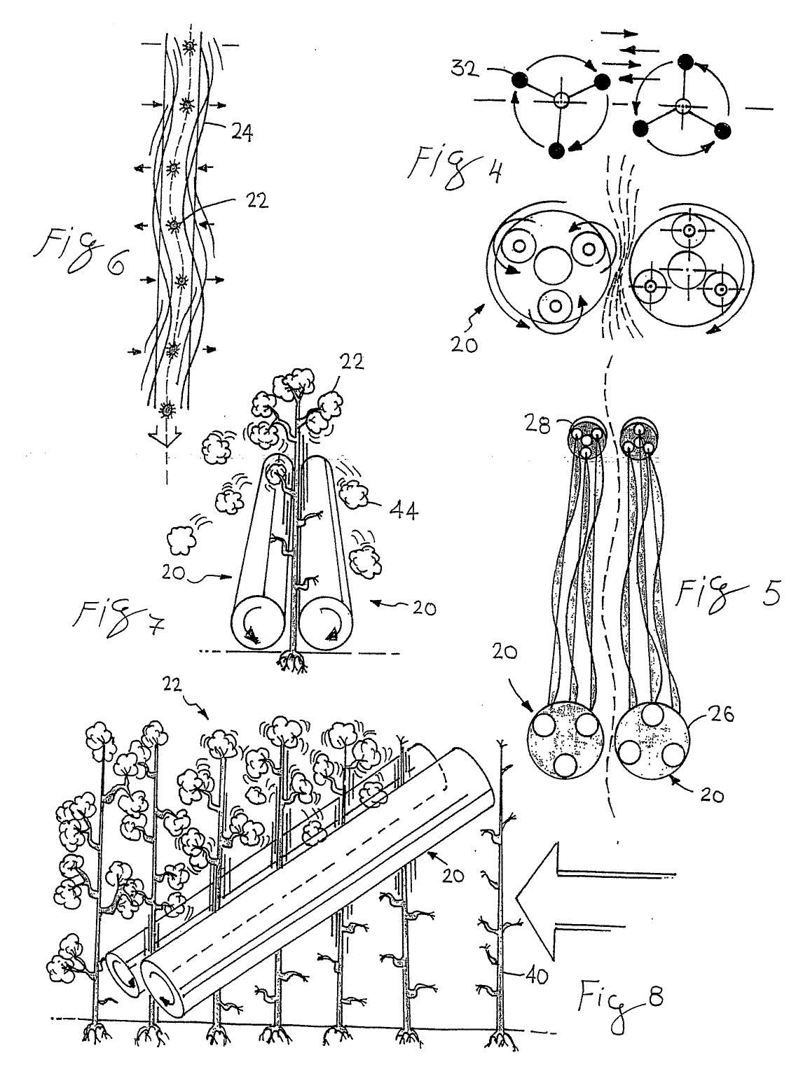

FIG. 5 illustrates the arrangement of two rotating bar assemblies, according to a preferred embodiment of the present invention. The assemblies are aligned substantially in parallel, and at an inclination, with the front end lower than the rear end (see also FIG. 8), spaced by a distance that allows a cotton plant to cross between the assemblies, yet allow the rotating rods to hit the plant. This means that the rotation span of the rods must reach beyond the diameter of the base plates 26.

FIG. 6 illustrates the motion of the rotating rods as the rotating rod assemblies are advanced over a row of plants 22.

FIG. 7 illustrates a frontal view the orientation and arrangement of a pair of rotating bar assemblies in front of a cotton plant. The front end—which is the end that meets first the plant—is at a low position, close to the ground, while the rear end is preferably higher than the cotton plant, allowing the device to cover the entire plant (the plant is shown in the figure to be higher, but this is just a graphic illusion drawn from the fact that it is situated in front of the device).

FIG. 8 illustrates the advance of a pair of rotating bar assemblies along a row of cotton plants 22. At first the lower cotton bolls are intercepted by the harvesting machine, and as it advances cotton bolls at higher elevations of the plant are collected. At the rear end bare plants 40 emerge.

The two pairs of rotating bar assemblies are each rotatable about their longitudinal axis and their rotation is made possible by transmission that may be coupled by a drive-shaft or by other means to the vehicles motor, or powered separately.

The revolving bar assemblies are preferably rotated in opposing directions (i.e. one clockwise and the other anticlockwise). It is recommended that the revolving bar assemblies be positioned close enough so that the effective cross-sections (i.e. the lateral span) of the revolving spiral bars slightly overlap. This set-up ensures that the cotton plant receives the jolting motion from both revolving bar assemblies. It is noted that the spiral configuration of the revolving rods bring about greater chances for the cotton bolls to be hit properly so as to impart them with the jolting force sufficient enough to remove them from the plant.

The tossed cotton bolls are trapped by a conveyer or other trapping device that is provided on the inside of the device's housing (11 in FIG. 1). The conveyer transfers the trapped bolls directly to a container or using transferring means, such as a vacuum pipe delivers the cotton bolls to the container where the bolls are collected and kept until they are unloaded.

It is important to render the revolving bar circular balance as imbalanced revolving member may easily break or pop out of its position.

It may be necessary to provide some maneuverability to the position of the revolving bar assemblies so that they may be drawn closer or apart depending on the anticipated sizes of the cotton plants that are to pass through. This is because the cotton plant may be so small it is necessary to bring the revolving bar assemblies closer together in order to effectively hit the plant so as to detach the bolls from the stem. Alternatively the plants may be larger making it necessary to draw the revolving bar assemblies apart.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A harvesting device for harvesting cotton or similar crop plants comprising:
a housing mountable on a vehicle or a cart and adapted to be advanced along a row of the plants and provided with a gap through which each plant may pass through as the housing is advanced;
two substantially parallel elongated revolvable bar assemblies placed in housing, each consisting of at least one spiral bar rotatable about a first axis, the first axis revolvable about a second axis,
whereby when the device is advanced along a row of plants and the revolvable bar assemblies are rotated the spiral bars impart a plant as it passes through the gap in the housing a series of lashes that cause separation of cotton bolls from the plant and their conveying and collection.

2. The device as claimed in claim 1, wherein said housing is mounted on a self-propelled motor-powered vehicle.

3. The device as claimed in claim 2, wherein the revolvable bar assemblies are powered by the motor of the self-propelled motor-powered vehicle.

4. The device as claimed in claim 1, wherein each of the revolvable bar assemblies comprises two or more spiral bars rotatable about a first axis, the first axis revolvable about a second axis.

5. The device as claimed in claim 3, wherein each of the revolvable bar assemblies comprises three spiral bars rotatable about a first axis, the first axis revolvable about a second axis.

6. The device as claimed in claim 1, wherein said two substantially parallel elongated revolvable members are driven simultaneously and in synchrony by a transmission consisting of interlaced transmission cogs.

7. The device as claimed in claim 1 wherein said two substantially parallel elongated revolvable members are adapted to be drawn closer or further apart so as to allow different sizes of plants to be harvested.

8. The device as claimed in claim 1, wherein the revolvable bar assemblies are positioned diagonally with respect to the ground.

9. The device as claimed in claim 1, wherein the revolvable bar assemblies are rotatable in opposite directions.
